(19) United States
(12) Patent Application Publication
(10) Pub. No.: US 2014/0096537 A1
(43) Pub. Date: Apr. 10, 2014

(54) Thin Metal Duct Damper

(71) Applicant: Ryan C. McMahon, North Palm Beach, FL (US)

(72) Inventor: Ryan C. McMahon, North Palm Beach, FL (US)

(73) Assignee: Pratt & Whitney

(21) Appl. No.: 13/544,103

(22) Filed: Jul. 9, 2012

(51) Int. Cl. F02C 7/20

(52) U.S. Cl. CPC F02C 7/20
USPC 60/796

(57) ABSTRACT

A damper for damping vibration of a structural member of a gas turbine engine is disclosed. The damper may include a first metal mesh pad which abuts an outer circumferential surface of the structural member, and a garter spring which abuts the first metal mesh pad. Both the metal mesh pad and the garter spring may completely or partially encircle the structural member. Alternatively, the damper may include a damper cover which encloses the first metal mesh pad and the garter spring and which abuts the outer surface of the structural member. A second metal mesh pad may be inserted between the damper cover and the garter spring. A gas turbine engine which comprises such a damper is also disclosed.

### GOVERNMENT RIGHTS STATEMENT

The United States Government has rights in this invention pursuant to Contract No. N00019-02-C-3003 awarded by the Department of the Air Force.

### FIELD OF THE DISCLOSURE

The present disclosure generally relates to gas turbine engines and, more particularly, relates to a vibration damper for gas turbine engine structural members.

### BACKGROUND OF THE DISCLOSURE

A gas turbine engine typically includes a compressor, at least one combustor, and a turbine. The compressor and turbine each include a number of rows of blades attached to a rotating cylinder. In operation, the air is pressurized in a compressor and is then directed toward the combustor. Fuel is continuously injected into the combustor together with the compressed air. The mixture of fuel and air is ignited to create combustion gases that enter the turbine, which is rotatably driven as the high temperature, high pressure combustion gases expand in passing over the blades forming the turbine. Since the turbine is connected to the compressor via a shaft, the combustion gases that drive the turbine also drive the compressor, thereby restarting the ignition and combustion cycle.

Since the gas turbine engine operates at high temperatures and rotational speeds, its components are subject to large centrifugal forces and experience high aerodynamic loads, all of which contribute to a high vibration environment. The modes of vibrations in turn significantly stress components of the engine, including but not limited to fan blades, compressor blades, turbine blades, vanes, conduits, ducts and housing. Such vibrations might result in high cycle fatigue and premature wear of the blades, ducts and other engine components.

A number of approaches have been used to reduce the vibrations in turbine engines. One known method is friction damping which damps the vibrations in the blades by utilizing a friction damping plate member attached to the underlying blade. When the blades are driven by the combustion gases, the plate member rubs against the blade and dissipates the vibrational energy. One problem with friction damping is that the wearing of the plate members and blades is also common due to the friction rubbing action which leads to a limited life of the friction damping system. An elastic damping band which encircles and contacts an outer circumference of a turbine engine housing is another form of static friction damping.

Another known method is viscoelastic damping which utilizes a layer of viscoelastic material applied to components of the engine, for example, the blade, to absorb and dissipate the vibrations. This approach is undesirable because it can increase the weight of the blades and reduce the efficiency of the engine. Further, no known viscoelastic material can survive in the turbine section or have long life spans under high centrifugal loads.

Other vibration dampers utilize hardware attached to components of the engine to reduce vibrations. For example, it has become known to damp high frequency vibrations in turbine engine housings by applying damping lacquer coatings, damping putties or mastics, or damping foils onto the outer circumference of the housing. One disadvantage of such known damping methods is that it is difficult to remove the damping media during subsequent inspections and maintenance operations.

Thin sheet metal structures in high acoustic environments present a difficult case for damping vibrations in a turbine engine without adding additional fixities or hardware. One solution to this problem is to add riveted joints on the thin sheet metal structure and take advantage of slipping at the joint to provide damping. Another solution is to use damping bands such as local panels and doublers as a damping interface. However, these approaches either suffer from the potential high cycle fatigue caused by holes drilled in the thin metal structure or are limited to application conditions such as locations and working temperatures.

To better answer the challenges raised by the gas turbine industry to produce reliable and high-performance gas turbines, it is therefore desirable to provide a vibration damper which damps vibrations of thin sheet metal structures without drilling holes thereon or changing the design thereof.

### SUMMARY OF THE DISCLOSURE

In accordance with one aspect of the present disclosure, a damper for damping vibration of a structural member of a turbine engine is therefore disclosed. The damper may include a first metal mesh pad including a first surface which abuts an outer circumferential surface of the structural member; and a garter spring which abuts a second surface of the first metal mesh pad.

In a refinement, the first metal mesh pad may encircle the structural member around the outer circumferential surface thereof.

In another refinement, the garter spring may encircle the structural member around the outer circumferential surface thereof.

In another refinement, the damper may further include a damper cover and a second metal mesh pad. The damp cover may abut the outer circumferential surface of the structural member and may form a cavity between the damper cover and the outer circumferential surface of the structural member, wherein at least a portion of the first metal mesh pad and at least a portion of the garter spring are in the cavity. The second metal mesh pad may be inserted between the damper cover and the garter spring, wherein the second metal mesh pad abuts the damper cover and the garter spring.

In another refinement, the damper cover may encircle the structural member around the outer circumferential surface of the structural member.

In another refinement, the first metal mesh pad may be constructed from first wires with a first diameter less than about 0.100 inches.

In another refinement, the first wires of the first metal mesh pad may be knitted to form the first metal mesh pad.

In another refinement, the first wires of the first metal mesh pad may be woven to form the first metal mesh pad.

In another refinement, the second metal mesh pad may be constructed from second wires with a first diameter less than about 0.100 inches.

In another refinement, the second wires of the second metal mesh pad may be knitted to form the second metal mesh pad.

In still another refinement, the second wires of the second metal mesh pad may be woven to form the second metal mesh pad.

In accordance with another aspect of the present disclosure, a gas turbine engine is disclosed. The gas turbine engine may include a compressor; a combustors chamber downstream of the compressor; a turbine downstream of the combustor chamber; a first metal mesh pad including a first surface which abuts an outer circumferential surface of a structural member of the gas turbine engine; and a garter spring which abuts a second surface of the first metal mesh pad.

In a refinement, the gas turbine engine may include the first metal mesh pad which encircles the structural member around the outer circumferential surface thereof.

In another refinement, the gas turbine engine may include the garter spring which encircles the structural member around the outer circumferential surface thereof.

In another refinement, the gas turbine engine may further include a damper cover and a second metal mesh pad. The damper cover may abut the outer circumferential surface of the structural member and may form a cavity between the damper cover and the outer circumferential surface of the structural member, wherein at least a portion of the first metal mesh pad and at least a portion of the garter spring are in the cavity. The second metal mesh pad may be inserted between the damper cover and the garter spring, wherein the second metal mesh pad abuts the damper cover and the garter spring.

In another refinement, the gas turbine engine may include the damper cover which encircles the structural member around the outer circumferential surface thereof.

In another refinement, the gas turbine engine may include the first metal mesh pad which is constructed from first wires with a first diameter less than about 0.100 inches.

In another refinement, the gas turbine engine may include the first wires which may be knitted to form the first metal mesh pad.

In another refinement, the gas turbine engine may include the first wires which may be woven to form the first metal mesh pad.

In still another refinement, the gas turbine engine may include the second metal mesh pad which may be constructed from second wires with a first diameter less than about 0.100 inches.

Further forms, embodiments, features, advantages, benefits, and aspects of the present disclosure will become more readily apparent from the following drawings and descriptions provided herein.

### BRIEF DESCRIPTION OF THE DRAWINGS

FIG. 1 is a cross-sectional view of a gas turbine engine constructed in accordance with the teachings of this disclosure;

FIG. 2 is a fragmentary perspective view of an embodiment of a thin metal duct damper according to the present disclosure;

FIG. 3 is a longitudinal sectional view of the thin metal duct damper in FIG. 2 according to the present disclosure and taken along line 3-3 of FIG. 2;

FIG. 4 is a fragmentary perspective view of another embodiment of a thin metal duct damper according to the present disclosure;

FIG. 5 is a longitudinal sectional view of the thin metal duct damper in FIG. 4 according to the present disclosure and taken along line 5-5 of FIG. 4;

FIG. 6 is a longitudinal sectional view of still another embodiment of a thin metal duct damper according to the present disclosure and taken along a similar plane as with FIG. 5;

FIG. 7 is a side elevation view of garter spring according to an embodiment of the present disclosure; and

FIG. 8 shows a side elevation view of the garter spring in FIG. 7 but in a connected configuration according to the present disclosure.

Before proceeding with the detailed description, it is to be appreciated that the following detailed description is merely exemplary in nature and is not intended to limit the invention or the application and uses thereof. In this regard, it is to be additionally appreciated that the described embodiment is not limited to use in conjunction with a particular thin metal duct or a particular type of gas turbine. Hence, although the present disclosure is, for convenience of explanation, depicted and described as shown in certain illustrative embodiments, it will be appreciated that it can be implemented in various other types of embodiments and equivalents, and in various other systems and environments.

### DETAILED DESCRIPTION OF THE DISCLOSURE

Damping as referred to herein is defined to mean reducing the vibratory strain in a component, whether accomplished by dissipation or by stiffening. For example, a sliding friction device which is a form of passive vibration damping, can damp a vibratory motion via the dissipation of energy. On the other hand, stiffening the structure of a component of the engine may adjust the resonant frequency thereof to a value that is different from that of a vibratory force, thus may reduce the impact of vibration.

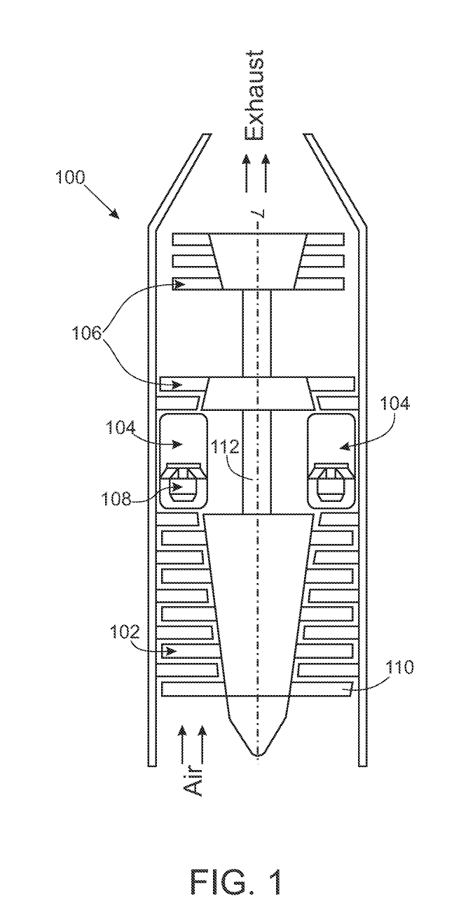

Referring now to the drawings, and with specific reference to FIG. 1, there is depicted an exemplary gas turbine 100 wherein various embodiments of the present disclosure may be utilized. In this example, the industrial gas turbine 100 may include a compressor 102, a combustor chamber 104 downstream of the compressor 102, and a turbine 106 downstream of the combustor chamber 104, each disposed coaxially about an engine centerline axis L. The combustor chamber 104 typically includes multiple fuel injectors or nozzles 108. During an operation, air is pressurized in the compressor 102, and mixed with fuels, which are transported through fuel nozzles 108, in the combustor 104 to generate hot gases. The hot gases flow through the turbine 106, which extracts energy from the hot gases. The turbine 106 then powers the compressor 102 and the fan section 110 through a rotor shaft 112. In power generation applications, the turbine 106 may connect to an electric generator to generate electricity; while in aerospace applications, the exhaust of the turbine 106 can be used to create thrust.

Due to the rotation of the rotor shaft 112 and fan blades coupled with other factors such as pressure variations across the compressor 102, harmonic waves or other forms of vibration can develop in the structural members of the gas turbine 100, such as thin metal structures, for example, conduits, ducts and flow sleeves. The vibration can be destructive to the engine structural members if left unchecked. To reduce the weight and cost, some structural members of a turbine engine are of a thin-walled construction, and thus are particularly susceptible to vibration.

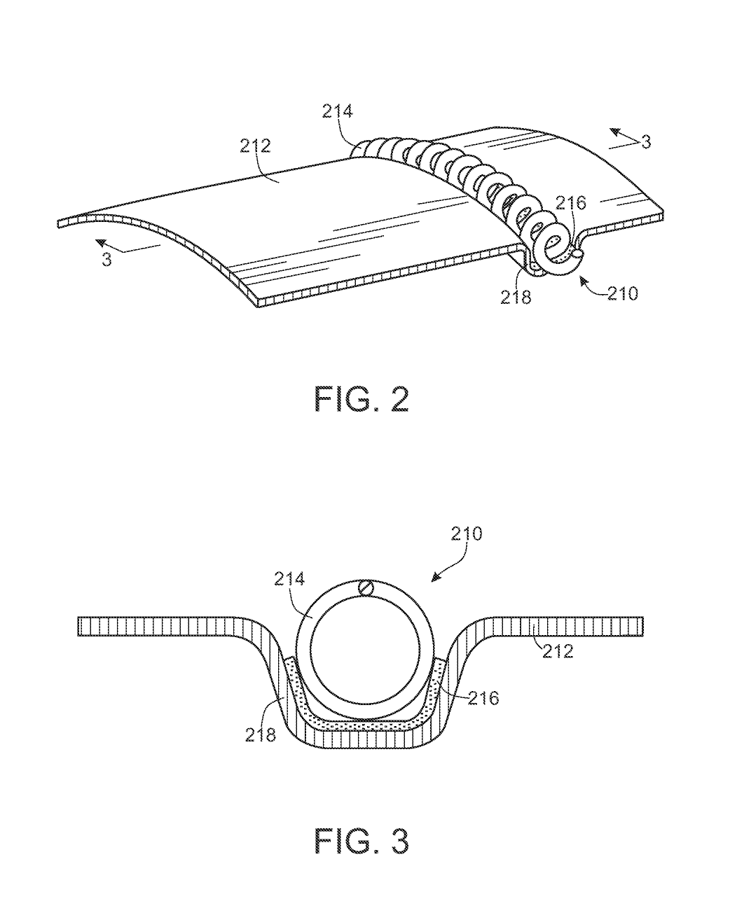

To damp the vibration in a turbine engine, especially the vibration of thin metal ducts, a thin metal duct damper 210 according to an embodiment of the present disclosure may be employed as illustrated in FIGS. 2-3. The thin metal duct damper 210 may be assembled on the outer surface of a thin metal duct 212, and may comprise a circumferentially extending garter spring 214 and a circumferentially extending bottom metal mesh pad 216. In the example shown, the thin metal duct 212 may have a local geometrical feature such as a groove 218 where the metal duct damper 210 can be placed. Specifically, the metal mesh pad 216 may provide a cushion between the outer surface of the thin metal duct 212 and the garter spring 214. Further, the metal mesh pad 216 may provide a surface which the garter spring 214 can rest on so as to encircle outer surface of the metal mesh pad 216 in a contour fitting manner.

In one embodiment, the metal mesh pad 216 may completely encircle the whole circumference of the thin metal duct 212. In another embodiment, the metal mesh pad 216 may partially encircle the circumference of the thin metal duct 212. Similarly, the garter spring 214 may completely encircle the whole circumference of the thin metal duct 212; or the garter spring 214 may partially encircle the circumference of the thin metal duct 212. The metal mesh pad 216 is spot welded or otherwise secured to the outer surface of the thin metal duct.

The size and dimension for the garter spring 214 and the metal mesh pad 216 can be selected to match the depth and/or width of the groove 218. The garter spring 214 and the metal mesh pad 216 may be made of the same material or may be made of different materials. Although the thin metal duct damper 210 and its components are shown as having certain relative dimensions, such dimensions are only exemplary and other relative dimensions are possible.

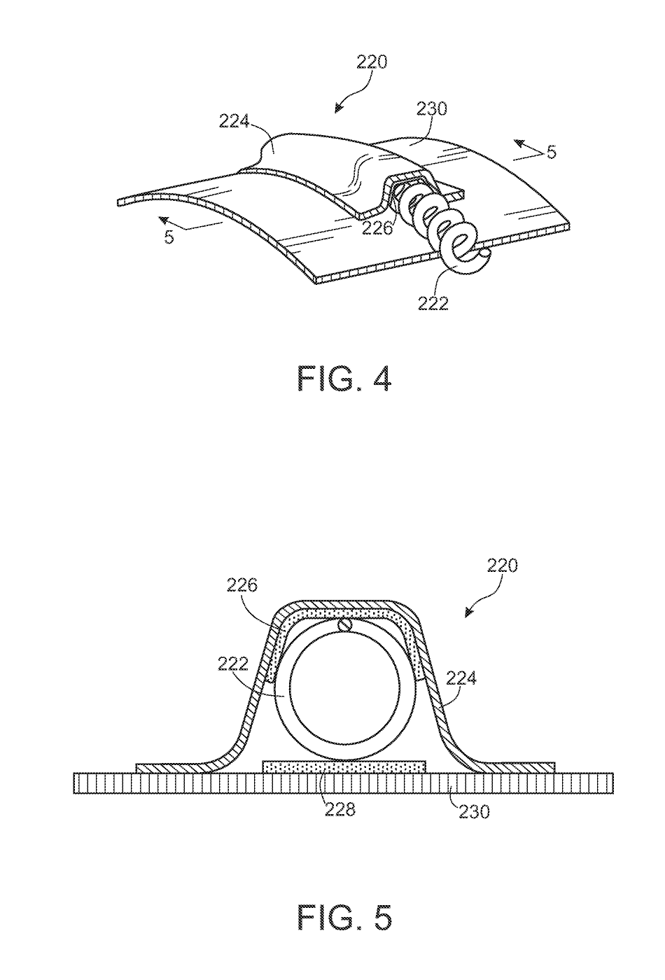

Turning to FIGS. 4-5, a thin metal duct damper 220 is illustrated according to another embodiment of the present disclosure. The thin metal duct damper 220 may comprise a circumferentially extending garter spring 222, a damper cover 224, a circumferentially extending top metal mesh pad 226, and a circumferentially extending bottom metal mesh pad 228. The thin metal duct damper 220 may be assembled on the outer surface of a thin metal duct 230.

In the example shown in FIGS. 4-5, the damper cover 224 may be attached to the outer surface of the thin metal duct 230 at selected locations. Various methods may be used to attach the cover 224 onto the duct 230. Such methods may include, for example, tack welding or curable adhesives. Not only does the cover 224 secure the garter spring 222 and pads 226 and 228 in place, but it also allows vibrations from the thin metal duct 230 to be transmitted to and absorbed by the top metal mesh pad 226, which may not be in contact with the duct 230. On the other hand, the bottom metal mesh pad 228 may provide a cushion between the outer surface of the thin metal duct 230 and the garter spring 222. Further, the metal mesh pad 228 may provide a surface which the garter spring 222 can rest on so as to encircle the outer circumference of the thin metal duct 230 in a contour fitting manner.

The thin metal duct damper 220 may be applied in situations where there is no local feature, for example, a groove, on the thin metal duct to secure the attachment of the damper. Although the thin metal duct damper 220 and its components are shown as having certain relative dimensions, such dimensions are only exemplary and other relative dimensions are possible.

Similar to the first embodiment, the damper cover 224 may completely encircle the circumference of the thin metal duct 230. In another embodiment, the damper cover 224 may partially encircle the circumference of the thin metal duct 230. The damper cover 224 may be attached to a local feature, for example, a protrusion, on the surface of the thin metal duct 230. The metal mesh pads 226 and/or 228 themselves may completely encircle the whole circumference of the thin metal duct 230, or partially encircle the circumference of the thin metal duct 230. Similarly, the garter spring 222 may completely encircle the whole circumference of the thin metal duct 230, or partially encircle the circumference of the thin metal duct 230.

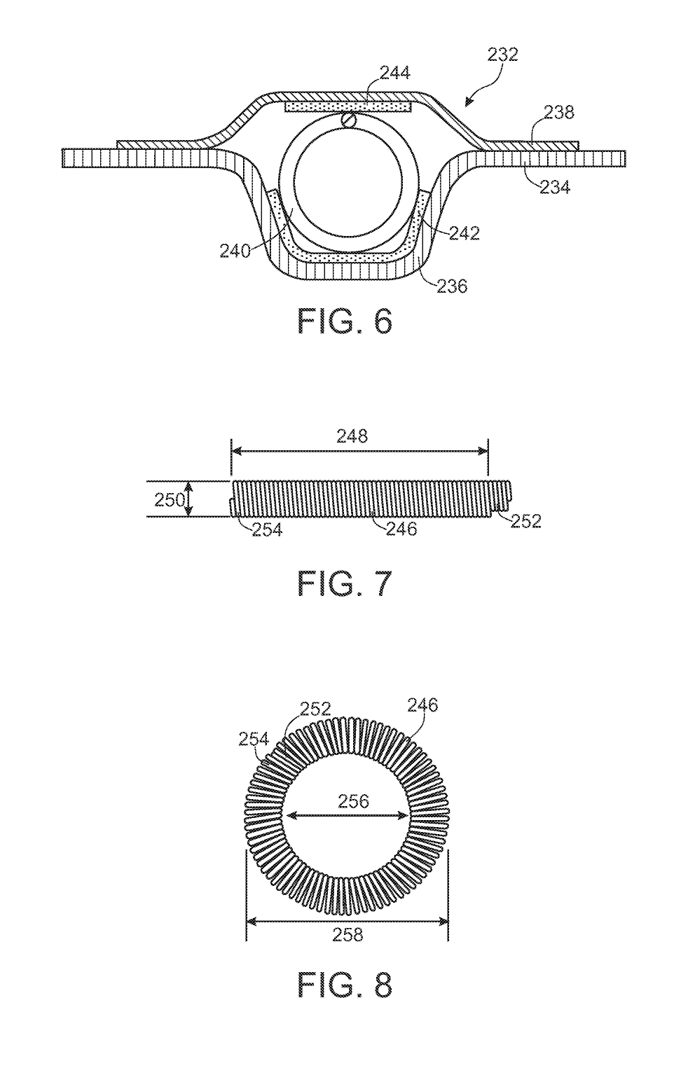

FIG. 6 illustrates in detail still an embodiment of the thin metal duct damper 232 according to the present disclosure. The thin metal duct damper 232 may be assembled on the outer surface of a thin metal duct 234 which has a local feature, groove 236. The thin metal duct damper 232 may comprise a damper cover 238, a circumferentially extending garter spring 240, a circumferentially extending bottom metal mesh pad 242, and a circumferentially extending top metal mesh pad 244. In the example depicted in FIG. 6, the damper cover 238 may be attached to the surface of the thin metal duct 230 and cover the groove 236. Various methods may be used to attach the cover 238 to the duct 34. Such methods may include, for example, tack welding or curable adhesives. Alternatively, the cover 238 may be attached to another local feature, for example, a protrusion, on the surface of the duct 234. The cover 238 may hold the garter spring 240 and the pads 42-44 inside the groove 236 under circumstances which would have caused the garter spring 240 and the pads 42-44 to pop out of the groove 236. Further, the metal mesh pad 242 may provide a cushion between the outer surface of the thin metal duct 234 and the garter spring 240. Moreover, the metal mesh pad 242 may provide a surface which the garter spring 240 can rest on so as to encircle the outer circumference of the thin metal duct 234 in a contour fitting manner. Although the thin metal duct damper 232 and its components are shown as having certain relative dimensions, such dimensions are only exemplary and other relative dimensions are possible.

As with the other embodiments, the damper cover 238 may completely or partially encircle the circumference of the thin metal duct 234, while the metal mesh pads 242 and/or 244 may completely or partially encircle the whole circumference of the thin metal duct 234. The garter spring 240 may also completely or partially encircle the circumference of the thin metal duct 234.

According to the present disclosure, a garter spring is a coil spring tied end-to-end to form a ring or a plurality of coil springs tied end-to-end to form a bigger ring in order to provide an even, radial compressive force around an object. As shown in FIGS. 7-8, a garter spring 246 may be made of a wire coiled helically. It may have a free length 248 and a coil diameter 250. One end of the garter spring 246 may be tapered to form a nib end 252 while the other end may form an open end 254. One way to connect and form a ring from a garter spring may be to insert the nib end 252 into the open end 254 and screw them together by back-winding to create a nib point as shown in FIG. 8. Other forms of connections are certainly possible. Once assembled into a ring shape, the garter spring 246 may have an assembled inner diameter (ID) 256 and an assembled outer diameter (OD) 58. Alternatively, a plurality of springs can be connected to form a bigger ring with a larger assembled ID. The connections between each individual springs may be the same or different.

Although FIG. 8 shows one way to join ends of garter springs to form a ring, other ways to connect spring fractions are possible. For example, a separate short section of spring called a connector may be used to join two spring fractions together by inserting into and winding with both ends of a garter spring. Another method may be to interlock loops on each end of the spring(s). Still another method is soldering the ends of springs.

In addition, although the garter spring 246 is shown as having certain relative dimensions, such dimensions are only exemplary and other relative dimensions are possible. Furthermore, although the garter spring 246 is shown as having only one coiled spring, as pointed out above, garter springs formed by a plurality of coil springs tied end-to-end are possible. The same or different connection(s) may be used to connect the plurality of coiled springs and form a bigger ring.

The materials for a garter spring may be carbon steel, stainless steel, any other suitable materials, or combinations thereof. The suitable materials may make springs with desirable properties for the working condition of the particular thin metal duct damper.

The garter spring may absorb vibrations of the engine at low temperature working conditions and at high temperature working conditions. It may also have a long cycle life which matches the continuous high-speed operation of engines. Further, the garter spring may easily be exchanged during maintenance without causing substantial damage of the thin metal duct which the garter spring encircles.

On the other hand, a metal mesh pad may be made from metal wires which are knitted or woven with certain predetermined patterns, and then compressed into its final shape. Since the metal mesh pad may comprise interlocking loop constructions, the knitted/woven metal stands may couple resiliency with high damping characteristics and/or nonlinear spring rates to absorb the shock and vibration of an engine via hysteresis. For example, the interlocking loops of a metal mesh pad may move relative to each other on the same plane without distorting the metal mesh pad, giving the knitted/woven metal mesh pad a two-way stretch. Further, since each loop may act as a small spring when subjected to tensile or compressive stress, the knitted/woven metal mesh pad may have an inherent resiliency. Accordingly, metal mesh pad may provide high mechanical, oil-free damping characteristics and no-linear spring rates, both of which may effectively control vibration and mechanical shock in order to protect the engine from dynamic overloads.

Metal mesh pads have been studied as a replacement for squeeze film dampers as a source of direct stiffness and damping at bearing locations. Potential advantage of metal mesh pads over squeeze film dampers may include: temperature insensitivity, oil-free operation, and the ability to contain large amplitude vibrations without magnifying their effects. The above advantage may apply to the damper of the present disclosure.

For example, metal mesh pads may provide both stiffness and damping, and may be applicable for use in the gas turbine engines because of their expected long cycle life which matches the continuous high-speed operation of engines. The high cycle life of metal mesh pads as dampers may be a result of using selected knitted or woven constructions from small metal wires. The resulting structures are then compressed in a die to reduce the percentage of open space in the mesh to a pre-determined level. Since the small wire has a diameter, for example, below about 0.200 inches, below about 0.100 inches, or below about 0.050 inches, it may limit bending stresses from displacement and increase the life of the metal mesh pads. Consequently, the metal mesh pads may meet the long life cycle of critically operated gas turbine engines, give high shock loading capability, and retain resiliency.

Metal mesh pads may be manufactured from spring steel wire, for example, IS 4454GRII, stainless steel wire, for example, AISI 302 & 304, phosphor bronze wire, nickel alloys, for example, Inconel alloys, or any other materials suitable for damping vibrations. The choice of materials for the metal mesh pad may be made according to the desired properties for the damper. The density, toughness, resilience, load capacity, friction profile and size of the metal mesh pad may be optimized to meet the damping need at selected locations on the thin metal duct.

When a metal mesh pad is interposed between a thin metal duct and a garter spring, it may be possible to suppress the wear of both the metal duct and the garter spring when the spring slide along the circumference of the thin metal duct during expansion and contraction of the garter spring.

Alternatively, plastic fibers may be knitted or woven in parallel with metal wires to increase resilience and reduction of surface friction of the final damper. The choice of suitable plastic fibers can be determined by a person skilled in the art after considering the working environment of and the mechanical requirement for the metal mesh pad. Regarding the starting materials used, the metal mesh pad may be made from copper, aluminum, tantalum, and austenitic nickel-chromium-based superalloy. Furthermore, the bulk material for the metal mesh pad may be flattened, calendared, corrugated, wound, or compressed to enhance its properties for specific applications of the metal mesh pad. In addition, the density of the metal mesh pad as a whole may be controlled, for example, from about 10% to about 70% of the density of the starting material for the metal mesh pad, and permit constructions of varying compression characteristics to meet a wide range of demanding applications in turbine engines. Other densities of the final metal mesh pad are entirely possible. Finally, the metal mesh pad may be spot-welded to the surface of the thin metal duct which the metal mesh pad encircles and contacts.

To control the degree of slipping in the presence of the metal mesh pad under working conditions, the surface of the thin metal duct which is in contact with the metal mesh pad may be coated with a suitable material and may not be hard-faced, so that the groove may provide a slipping surface for the metal mesh pad to better dissipate energy from the vibration.

Although a garter spring itself may provide damping effect, the addition of a metal mesh pad may provide a softer interface between the thin metal duct and the damper, thus may give better control of the damping effect and lead to less damage on the surface of the duct.

In addition, the material for the garter spring may have a different modulus of elasticity and a different density than the material of the metal mesh pad. Due to these different material properties, a different characteristic vibrational frequency of the garter spring as compared to that of the metal mesh pad may be obtained. Further, both the garter spring and the metal mesh pad may be made of materials different from those for the thin metal duct. Therefore, the garter spring and the metal mesh pad may achieve a detuning of the vibration system including the thin metal duct.

### INDUSTRIAL APPLICABILITY

From the foregoing, it can be seen that the present disclosure describes a thin metal duct damper which can find applicability in industrial gas turbines. Such a thin metal duct damper may also find industrial applicability in many other applications including, but not limited to, aerospace applications such as absorbing and damping engine vibrations for gas turbine engines.

Conventional gas turbine engines might have many thin metal ducts such as pipes, tubes, and sleeves. These thin metal ducts might suffer from engine vibrations generated during normal or extreme operation conditions of the engine. By combining the strengths of a garter spring damper and a metal mesh pad damper, the present disclosure enables better performing, longer-lasting and easier-to-maintain dampers for gas turbine engines. The present disclosure also provides novel alternatives to the present damping systems in order to meet advanced requirements for controlling vibrations of the engines. With the present design, an existing duct can be simply retrofitted with a new and effective damper. In addition, the new damper design can be tested using a lab test in order to gauge and improve the damping effect thereof. While the garter spring damper and the metal mesh pad damper eliminates the need to drill holes for damper in engines parts susceptible to high cycle fatigue, they are also temperature independent and functioning at elevated temperatures. Moreover, by changing damper positions to find the optimum location, eliminating joints added specifically for damping purposes, and eliminating assembly time to install rivets, the new system opens up new possibilities for gas turbine engine which have heretofore been limited by conventional dampers, and which may reduce repair costs and costs associated with defected damper and turbine failures. In sum, the thin metal duct damper of the present disclosure may improve the durability, reliability and life of a gas turbine engine with a relatively low cost.

While the invention has been described with reference to certain embodiments, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. A damper for damping vibration of a structural member of a turbine engine, comprising:
a first metal mesh pad including a first surface which abuts an outer circumferential surface of the structural member; and
a garter spring which abuts a second surface of the first metal mesh pad.

2. The damper of claim 1, wherein the first metal mesh pad encircles the structural member around the outer circumferential surface of the structural member.

3. The damper of claim 1, wherein the garter spring encircles the structural member around the outer circumferential surface of the structural member.

4. The damper of claim 1, further comprising:
a damper cover which abuts the outer circumferential surface of the structural member and which forms a cavity between the damper cover and the outer circumferential surface of the structural member, at least a portion of the first metal mesh pad and at least a portion of the garter spring being in the cavity; and
a second metal mesh pad between the damper cover and the garter spring, the second metal mesh pad abutting the damper cover and the garter spring.

5. The damper of claim 4, wherein the damper cover encircles the structural member around the outer circumferential surface of the structural member.

6. The damper of claim 1, wherein the first metal mesh pad is constructed from first wires with a first diameter less than about 0.100 inches.

7. The damper of claim 6, wherein the first wires of the first metal mesh pad are knitted to form the first metal mesh pad.

8. The damper of claim 6, wherein the first wires of the first metal mesh pad are woven to form the first metal mesh pad.

9. The damper of claim 4, wherein the second metal mesh pad is constructed from second wires with a second diameter less than about 0.100 inches.

10. The damper of claim 9, wherein the second wires of the second metal mesh pad are knitted to form the second metal mesh pad.

11. The damper of claim 9, wherein the second wires of the second metal mesh pad are woven to form the second metal mesh pad.

12. A gas turbine engine, comprising:
a compressor;
a combustor chamber downstream of the compressor;
a turbine downstream of the combustor chamber;
a first metal mesh pad including a first surface which abuts an outer circumferential surface of a structural member of the gas turbine engine; and
a garter spring which abuts a second surface of the first metal mesh pad.

13. The gas turbine engine of claim 12, wherein the first metal mesh pad encircles the structural member around the outer circumferential surface of the structural member.

14. The gas turbine engine of claim 12, wherein the garter spring encircles the structural member around the outer circumferential surface of the structural member.

15. The gas turbine engine of claim 12, further comprising:
a damper cover which abuts the outer circumferential surface of the structural member and which forms a cavity between the damper cover and the outer circumferential surface of the structural member, at least a portion of the first metal mesh pad and at least a portion of the garter spring being in the cavity; and
a second metal mesh pad between the damper cover and the garter spring, the second metal mesh pad abutting the damper cover and the garter spring.

16. The gas turbine engine of claim 15, wherein the damper cover encircles the structural member around the outer circumferential surface of the structural member.

17. The gas turbine engine of claim 12, wherein the first metal mesh pad is constructed from first wires with a first diameter less than about 0.100 inches.

18. The gas turbine engine of claim 17, wherein the first wires of the first metal mesh pad are knitted to form the first metal mesh pad.

19. The gas turbine engine of claim 17, wherein the first wires of the first metal mesh pad are woven to form the first metal mesh pad.

20. The gas turbine engine of claim 15, wherein the second metal mesh pad is constructed from second wires with a second diameter less than about 0.100 inches.
